(19) United States
(12) Patent Application Publication
(10) Pub. No.: US 2025/0211046 A1
(43) Pub. Date: Jun. 26, 2025

(54) ROTARY ELECTRIC MACHINE

(71) Applicant: HONDA MOTOR CO., LTD., Tokyo (JP)

(72) Inventors: Kentaro Fukui, Tokyo (JP); Junji Inoue, Wako-shi (JP)

(21) Appl. No.: 18/916,795

(22) Filed: Oct. 16, 2024

(30) Foreign Application Priority Data
Dec. 21, 2023 (JP) 2023-215958

(51) Int. Cl. H02K 3/24; H02K 1/20; H02K 11/25

(52) U.S. Cl. CPC H02K 3/24; H02K 1/20; H02K 11/25

(57) ABSTRACT

A rotary electric machine includes a stator, a rotor, a rotary electric machine case, and a temperature sensor. The stator has a stator core and a coil. The rotor rotates relative to the stator. The rotary electric machine case has an inner portion that accommodates the stator and the rotor, and a flow path of a cooling liquid for cooling the stator is provided in the inner portion. The temperature sensor is in contact with the coil at a position facing the flow path of the cooling liquid and determines the temperature of the coil. A recess groove is provided on an outer surface of the coil. An outside of the temperature sensor is covered by a holding member in a state where the temperature sensor is in contact with an inner surface of the recess groove of the coil, and the temperature sensor is attached to the coil via the holding member.

### CROSS-REFERENCE TO RELATED APPLICATION

Priority is claimed on Japanese Patent Application No. 2023-215958, filed on Dec. 21, 2023, the contents of which are incorporated herein by reference.

### BACKGROUND

### Field of the Invention

The present invention relates to a rotary electric machine such an electric motor or an electricity generator.

Background

A rotary electric machine such as an electric motor or an electricity generator includes a stator and a rotor that rotates relative to the stator. The stator includes a stator core and a coil that is wound around the stator core. In the stator core, for example, a back yoke (yoke) having a cylindrical shape and a plurality of teeth portions that protrude inward in a radial direction from the back yoke are integrally formed. A slot is formed between the teeth portions that are adjacent to each other in a circumferential direction such that the slot opens inward in the radial direction. A plurality of conductor wire portions of the coil are inserted into each slot.

This type of rotary electric machine is at a high temperature at the time of use since a coil generates heat. Therefore, it is important to accurately determine the temperature of the coil at the time of use and control a supply electric power of the rotary electric machine and an output of a cooling portion in accordance with the determined temperature. A rotary electric machine in which a temperature sensor such as a thermistor is provided in order to determine the temperature of the coil at the time of use is known (refer to Japanese Unexamined Patent Application, First Publication No. 2009-165340.

Further, as a method for efficiently cooling the coil of the rotary electric machine, a method in which a cooling liquid is caused to continuously flow to an inside of a rotary electric machine case that accommodates a stator is known (for example, refer to PCT International Publication No. WO 2021/032238).

### SUMMARY

In the rotary electric machine in which the cooling liquid is caused to continuously flow to the inside of the rotary electric machine case, when the temperature of the coil in the rotary electric machine case is determined by the temperature sensor such as a thermistor, a temperature determination portion of the coil and the temperature sensor easily enter a state of being constantly in contact with the cooling liquid. Therefore, a determination result by the temperature sensor is greatly affected by the temperature of the cooling liquid and is not likely to reflect an actual heat generation state of the coil in real time. At present, an improvement in this respect is desired.

An aspect of the present invention aims at providing a rotary electric machine capable of quickly and accurately determining the temperature of a coil that is arranged to face a flow path of a cooling liquid.

A rotary electric machine according to an aspect of the present invention includes: a stator having a stator core and a coil that is wound around the stator core; a rotor that rotates relative to the stator; a rotary electric machine case which has an inner portion that accommodates the stator and the rotor and in which a flow path of a cooling liquid for cooling the stator is provided in the inner portion; and a temperature sensor that is in contact with the coil at a position facing the flow path and determines the temperature of the coil, wherein a recess groove is provided on an outer surface of the coil, an outside of the temperature sensor is covered by a holding member in a state where the temperature sensor is in contact with an inner surface of the recess groove, and the temperature sensor is attached to the coil via the holding member.

According to the configuration described above, the temperature sensor is in contact with a portion having a large area in the recess groove of the outer surface of the coil, and the outside of the temperature sensor is covered by the holding member. Therefore, even when a temperature determination portion of the coil and the temperature sensor is arranged to face the flow path of the cooling liquid, a determination result of the temperature sensor is not greatly affected by the temperature of the cooling liquid. Accordingly, it becomes possible to quickly and accurately determine the temperature of the coil by the temperature sensor.

A holding groove that has a recess shape and holds an outer surface of the temperature sensor in a state of being in contact with the outer surface of the temperature sensor may be formed on the holding member.

In this case, since the outer surface of the temperature sensor is in contact with a portion having a large area in the holding groove of the holding member, the outer surface of the temperature sensor is less likely to come into contact with the cooling liquid. Therefore, the determination result of the temperature sensor is less likely to be affected by the temperature of the cooling liquid.

A first liquid room that faces an end surface on a first side in an axis direction of the stator core and a second liquid room that faces an end portion on a second side in the axis direction of the stator core may be provided inside the rotary electric machine case, a plurality of slots which penetrate through the stator core in the axis direction and through which the coil is inserted may be provided on the stator core, and the plurality of slots may cause the cooling liquid that is introduced into the first liquid room to flow to a side of the second liquid room and may constitute the flow path together with the first liquid room and the second liquid room.

In this case, almost the entire region of the stator core and the coil is submerged in the cooling liquid, and the stator core and the coil are efficiently cooled by the cooling liquid.

The temperature sensor may be attached to the coil by the holding member at a position that faces the second liquid room.

In this case, the temperature sensor is attached to the coil at a downstream-side position (a position that faces the second liquid room) of the flow path of the cooling liquid in the rotary electric machine case across the stator core.

Therefore, when the present configuration is employed, it becomes possible to quickly and accurately determine the temperature of a portion of the coil that is most likely to be at a high temperature by the temperature sensor.

The recess groove may be provided continuously along an extension direction of the coil also on a portion that is inserted into the slot of the coil, and the recess groove may form a communication gap in which the cooling liquid flows in an inside of the slot.

In this case, it becomes possible to cause the cooling liquid to flow along the outer surface of the coil in the slot by utilizing the recess groove on the outer surface of the coil. Therefore, when the present configuration is employed, it is possible to enhance the cooling efficiency of the coil.

In the rotary electric machine according to the aspect of the present invention, the temperature sensor is in contact with the portion having a large area in the recess groove of the outer surface of the coil, and the outside of the temperature sensor is covered by the holding member. Accordingly, when the rotary electric machine according to the aspect of the present invention is employed, it is possible to quickly and accurately determine the temperature of the coil that is arranged to face the flow path of the cooling liquid.

### BRIEF DESCRIPTION OF THE DRAWINGS

FIG. 1 is a longitudinal cross-sectional view of a rotary electric machine of an embodiment.

FIG. 2 is a cross-sectional view along a II-II line of FIG. 1 of the rotary electric machine of the embodiment.

FIG. 3 is a perspective view showing part of a stator of the embodiment.

FIG. 4 is a cross-sectional view of a holding member of the embodiment.

FIG. 5 is a cross-sectional view showing a state in which a temperature sensor is attached to a coil by the holding member of the embodiment.

### DESCRIPTION OF EMBODIMENTS

Hereinafter, an embodiment of the present invention will be described with reference to the drawings.

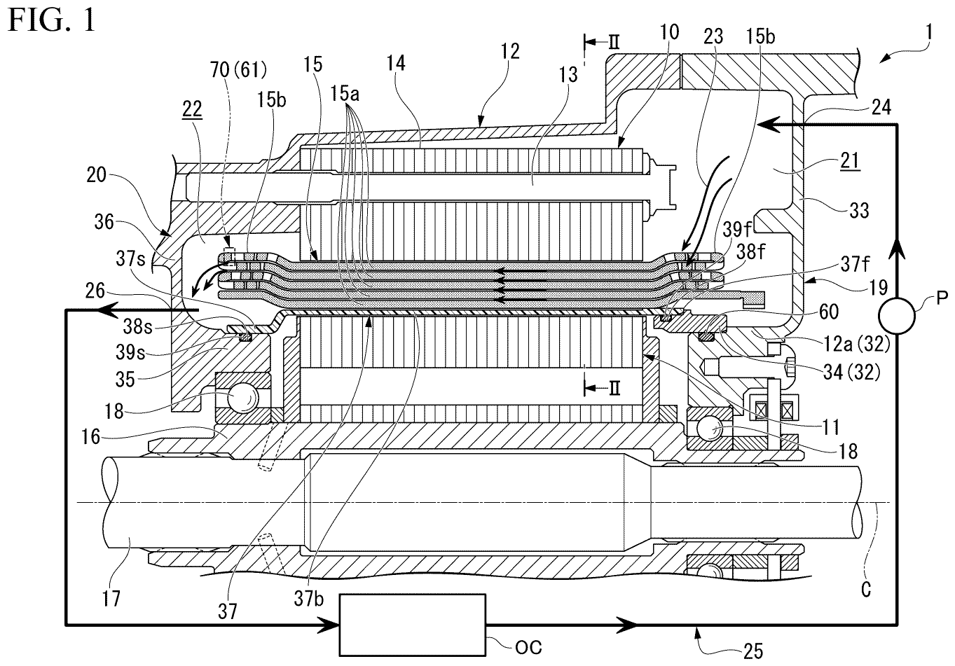

FIG. 1 is a longitudinal cross-sectional view of a rotary electric machine 1 of the present embodiment.

The rotary electric machine 1 of the present embodiment includes a stator 10 and a rotor 11. The stator 10 and the rotor 11 are accommodated in a rotary electric machine case 12. The stator 10 is fixed to an inside of the rotary electric machine case 12 by the fastening using a bolt 13 or the like. The stator 10 includes a stator core 14 having a cylindrical shape and a plurality of coils 15 that are wound around the stator core 14. The rotor 11 is rotatably arranged at an inside in a radial direction of the stator core 14 (stator 10).

A permanent magnet (not shown) is attached to the vicinity of an outer circumferential surface of the rotor 11. Further, the rotor 11 is rotatably supported integrally by a rotation shaft 17 via a sleeve 16. The rotation shaft 17 becomes an output shaft when the rotary electric machine 1 is used as a motor, and the rotation shaft 17 becomes a power input shaft when the rotary electric machine 1 is used as an electricity generator. The rotation shaft 17 and the sleeve 16 are rotatably supported by the rotary electric machine case 12 via a bearing 18.

In the following description, a direction parallel to a rotation axis line C of the rotor 11 is referred to as an axis direction, a rotation direction of the rotor 11 is referred to as a circumferential direction, and a radial direction of the rotor 11 that is orthogonal to the axis direction and the circumferential direction is referred to as a radial direction.

A first side case 19 and a second side case 20 that have an annular shape are arranged on a first end side and a second end side in the axis direction of the stator core 14. Main parts of the first side case 19 and the second side case 20 are formed of the rotary electric machine case 12.

The first side case 19 covers, from the outside, an end surface on a first side in the axis direction of the stator core 14 and an exposure portion of the coil 15 that protrudes from the end surface. The first side case 19 forms a first liquid room 21 having an annular shape together with the end surface on the first side in the axis direction of the stator core 14. An introduction port 24 for introducing a cooling liquid 23 into the first liquid room 21 is formed on the first side case 19. The introduction port 24 is connected to a circulation circuit 25 of the cooling liquid 23. The cooling liquid 23 that is introduced into the first liquid room 21 cools the exposure portion of the coil 15 that protrudes from the end surface on the first side of the stator core 14, then passes through the inside of the stator core 14, and flows into a second end side in the axis direction of the stator core 14.

The second side case 20 covers, from the outside, an end surface on a second side in the axis direction of the stator core 14 and an exposure portion of the coil 15 that protrudes from the end surface. The second side case 20 forms a second liquid room 22 having an annular shape together with the end surface on the second side in the axis direction of the stator core 14. The cooling liquid 23 that is introduced into the first liquid room 21 flows into the second liquid room 22 through the inside of the stator core 14. The cooling liquid 23 that is introduced into the second liquid room 22 cools the exposure portion of the coil 15 that protrudes from the end surface on the second side of the stator core 14. A discharge port 26 for discharging the cooling liquid 23 in the second liquid room 22 to the outside is formed on the second side case 20. The discharge port 26 is connected to the circulation circuit 25 of the cooling liquid 23. The cooling liquid 23 that has cooled the coil 15 in the second liquid room 22 is caused to return to the circulation circuit 25 from the discharge port 26.

In the circulation circuit 25, a supply pump P is connected to a middle of the circuit. A heat exchanger OC that cools the cooling liquid 23 by a heat exchange with outside air is connected to an upstream side of the supply pump P in the circulation circuit 25. A downstream side of the supply pump P is connected to the introduction port 24. Further, an upstream side of the heat exchanger OC in the circulation circuit 25 is connected to the discharge port 26.

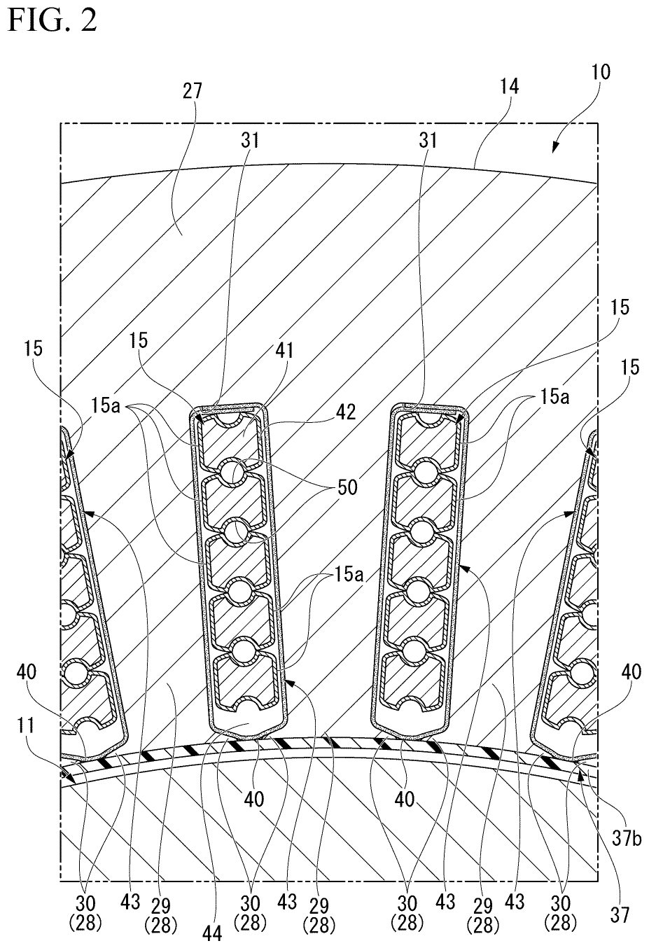

FIG. 2 is a cross-sectional view along a II-II line of FIG. 1 of the rotary electric machine 1.

The stator core 14 is formed, for example, by laminating a plurality of electromagnetic steel plates in the axis direction. In the stator core 14, as shown in FIG. 2, a back yoke 27 having a cylindrical shape and a plurality of teeth portions 28 that protrude inward in the radial direction from an inner circumferential portion of the back yoke 27 are integrally molded. The back yoke 27 is formed such that a cylinder center is matched with the rotation axis line C.

The teeth portions 28 are arranged to be spaced apart from each other in the circumferential direction. The teeth portion 28 is formed in a T shape when seen from the axis direction. That is, in the teeth portion 28, a teeth main body 29 that protrudes inward in the radial direction from the inner circumferential portion of the back yoke 27 and a flange portion 30 that projects to both sides in the circumferential direction from an inner end in the radial direction in the teeth main body 29 are integrally molded.

A slot 31 in which an inner side in the radial direction is opened is formed between the teeth portions 28 that are adjacent to each other in the circumferential direction. The slot 31 is formed to be surrounded by side walls that face each other of the teeth portions 28 that are adjacent to each other and an inner circumferential wall of the back yoke 27. The side wall of each teeth portion 28 is formed of a side portion of the teeth main body 29 and a side section of the flange portion 30. A portion of the slot 31 that is formed of the side portions of the right and left teeth main bodies 29 has a substantially constant width. Further, the width of a portion of the slot 31 that is formed of the side sections of the right and left flange portions 30 is narrower than the width of the portion that is formed of the side portions of the right and left teeth main bodies 29.

An opening 40 on the inside in the radial direction of each slot 31 is formed to be sandwiched by front end sections of the right and left (both sides in the circumferential direction) flange portions 30 of the slot 31. Further, each slot 31 penetrates through the stator core 14 in the axis direction.

In the coil 15, for example, three phases which are a U-phase, a V-phase, and a W-phase are provided. The coil 15 is constituted, for example, by connecting a plurality of segment coils to each other. In the coil 15, an outer surface of a core wire 41 made of a metal is covered by an insulation film 42. Further, the coil 15 is constituted of a rectangular wire. That is, the shape of a cross section that is orthogonal to an extension direction of the coil 15 is formed in a substantially rectangular shape.

Each coil 15 is inserted along the axis direction through the slot 31 of the stator core 14 and is wound around a corresponding teeth portion 28 in that state.

Hereinafter, a portion of the coil 15 that is inserted through the slot 31 is referred to as a “slot insertion portion 15a”, and a portion that is exposed to the outside of the slot 31 and is drawn in a direction of another slot 31 is referred to as a “drawn portion 15b”.

As shown in FIG. 2, a plurality of slot insertion portions 15a of the coil 15 are inserted through each slot 31 in a step manner. The plurality of slot insertion portions 15a that are inserted through the same slot 31 are aligned in a line along the radial direction. In the present embodiment, for example, five slot insertion portions 15a are inserted through the same slot 31. However, the number of the slot insertion portions 15a that are inserted through the same slot 31 is not limited to this and can be arbitrarily set.

In a state where the plurality of slot insertion portions 15a that are inserted and arranged in each slot 31 are bundled so as to be aligned in a line in parallel with each other, and the periphery of the plurality of slot insertion portions 15a is covered by a sheet of a foamable insulation member 43. For example, it is possible to employ a foamable insulation member 43 in which a foamable adhesion bond is arranged (applied) on a surface (a surface that faces outward in a state of covering the slot insertion portion 15a) of a base material sheet having an electrical insulation property, and a non-foamable adhesion bond is arranged (applied) on a rear surface of the base material sheet. The foamable insulation member 43 is inserted and arranged in a corresponding slot 31 together with the plurality of slot insertion portions 15a in a state of covering the periphery of the plurality of slot insertion portions 15a. Then, by performing a heating treatment or the like, the foamable insulation member 43 foams in the corresponding slot 31. As a result, part of the outer surface of the foamable insulation member 43 is bonded to the inner wall of the slot 31.

Even after the slot insertion portion 15a of the coil 15 and the foamable insulation member 43 are arranged in the slot 31 as described above, a gap for causing a first end side in the axis direction of the stator core 14 to communicate with a second end side is ensured at the inside of the slot 31. The gap constitutes a cooling liquid passage 44 for causing the cooling liquid that is introduced into the first liquid room 21 to flow to the second liquid room 22 side. The gap that constitutes the cooling liquid passage 44 is, specifically, a gap between an inner surface of the foamable insulation member 43 and the slot insertion portion 15a, a gap between the slot insertion portions 15a that are adjacent to each other, a gap between an outer surface of the foamable insulation member 43 and an inner wall of the slot 31, or the like. The cooling liquid 23 that flows through the cooling liquid passage 44 in the slot 31 absorbs heat of the slot insertion portion 15a of the coil 15.

A recess groove 50 that extends along the axis direction of the stator core 14 is formed on a surface that faces outward in the radial direction and a surface that faces inward in the radial direction of each slot insertion portion 15a which is arranged in the slot 31.

The recess groove 50 is formed to be recessed in a substantially arc shape toward a middle region in a width direction of the slot insertion portion 15a. When the plurality of slot insertion portions 15a are arranged together with the foamable insulation member 43 in the slot 31, the recess groove 50 forms a gap (communication gap) that extends substantially along the axis direction between end surfaces that face each other of the slot insertion portions 15a that are adjacent to each other in the radial direction and between an end surface of the slot insertion portion 15a and an inner surface of the foamable insulation member 43.

In the present embodiment, the first liquid room 21, the plurality of slots 31 of the stator core 14, and the second liquid room 22 constitute a flow path of the cooling liquid in the rotary electric machine case 12.

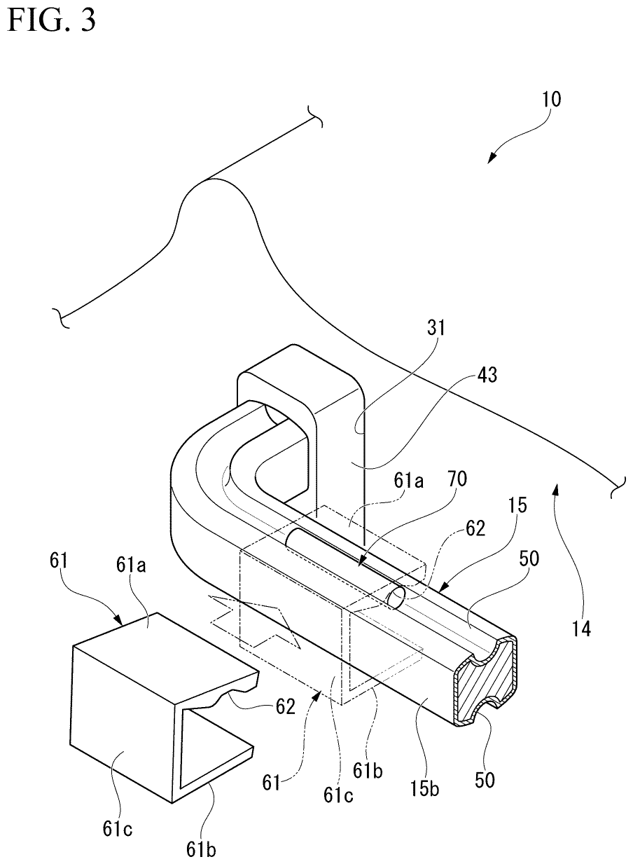

FIG. 3 is a perspective view showing an end portion of the stator 10 on a side that faces the second liquid room 22.

As shown in FIG. 3, so as to continue to the recess groove 50 of the slot insertion portion 15a described above, a similar recess groove 50 is formed on the drawn portion 15b of the coil 15 that is drawn from the slot 31 of the stator core 14. In the case of an example shown in FIG. 3, the recess groove 50 having an arc shape is formed on an upper surface and a lower surface of the drawn portion 15b along an extension direction of the drawn portion 15b. In the case of the present embodiment, a similar recess groove 50 is also formed on a drawn portion 15b on a side that faces the first liquid room 21.

A temperature sensor 70 for determining the temperature of the coil 15 is attached to part of the drawn portion 15b on the side that faces the second liquid room 22. The temperature sensor 70 is constituted of, for example, a thermistor or the like. The temperature sensor 70 is in contact with the coil 15 (drawn portion 15b) and determines the temperature of the contact portion. The temperature sensor 70 is connected to a control portion of the rotary electric machine 1 by a wiring (not shown). The control portion controls an electric power supply portion and a cooling portion (for example, the supply pump P of the circulation circuit 25) in response to an input signal from the temperature sensor 70.

In the present embodiment, an outer surface shape of the temperature sensor 70 is formed in a substantially cylindrical shape. The temperature sensor 70 is attached to the coil 15 by a holding member 61 in a state where an outer surface (outer circumferential surface) of the temperature sensor is pressed to the inner surface of the recess groove 50 on a first side of the drawn portion 15b.

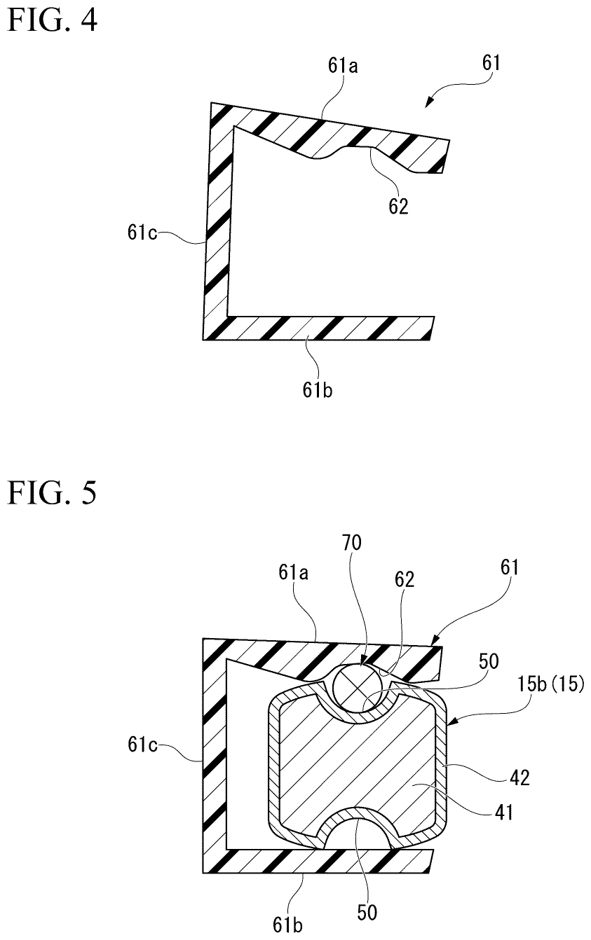

FIG. 4 is a cross-sectional view of the holding member 61, and FIG. 5 is a cross-sectional view showing a state in which the temperature sensor 70 is attached to the coil 15 by the holding member 61.

The holding member 61 is formed, for example, in a cross-sectional shape having a substantially U shape in which a pair of sandwiching walls 61a, 61b are connected by a connection wall 61c. In the case of the present embodiment, the holding member 61 is integrally formed of a resin material. The holding member 61 sandwiches the temperature sensor 70 and the drawn portion 15b by the pair of sandwiching walls 61a, 61b in a state where the temperature sensor 70 is placed in the recess groove 50 of the drawn portion 15b of the coil 15. By pressing the drawn portion 15b and the temperature sensor 70 to enter a space between the sandwiching walls 61a, 61b while pressing and expanding the sandwiching walls 61a, 61b, the holding member 61 can fix the temperature sensor 70 to the drawn portion 15b by the elasticity of the sandwiching walls 61a, 61b.

A holding groove 62 that has a recess shape and holds an outer surface of the temperature sensor 70 in a state of being in contact with the outer surface of the temperature sensor 70 is formed on one sandwiching wall 61a of the holding member 61. The holding groove 62 extends so as to be substantially parallel to an extension direction of the recess groove 50 of the drawn portion 15b when the sandwiching walls 61a, 61b sandwich the temperature sensor 70 and the drawn portion 15b. Accordingly, when the holding member 61 sandwiches the temperature sensor 70 and the drawn portion 15b by the sandwiching walls 61a, 61b, the inner surface of the holding groove 62 is in contact with the outer surface of the temperature sensor 70 so as to cover the outer surface of the temperature sensor 70 and presses the remaining portion of the outer surface of the temperature sensor 70 to the inner surface of the recess groove 50 of the drawn portion 15b in that state.

Further, as shown in FIG. 1, the first side case 19 on a first end side in the axis direction of the stator core 14 includes a first inner circumferential wall 32 that faces the first liquid room 21. The first inner circumferential wall 32 protrudes in a cylindrical shape from an inner end portion in the radial direction of an end side wall 33 of the first side case 19 located at an outer end in the axis direction of the first liquid room 21 toward an end surface on a first side in the axis direction of the rotor 11. In the case of the present embodiment, the first inner circumferential wall 32 is constituted of a circumferential wall main body portion 12a that is formed integrally with the rotary electric machine case 12 (end side wall 33) and a cylindrical member 34 as a separate body that is attached to an outer circumferential surface on an extension end side of the circumferential wall main body portion 12a. A space between the circumferential wall main body portion 12a and the cylindrical member 34 is sealed by a seal member 60 having an annular shape.

However, the entire first inner circumferential wall 32 may be formed integrally with the rotary electric machine case 12 (end side wall 33).

Further, the second side case 20 on a second end side in the axis direction of the stator core 14 includes a second inner circumferential wall 35 that faces the second liquid room 22. The second inner circumferential wall 35 protrudes in a cylindrical shape from an inner end portion in the radial direction of an end side wall 36 of the second side case 20 located at an outer end in the axis direction of the second liquid room 22 toward an end surface on a second side in the axis direction of the rotor 11. In the case of the present embodiment, the second inner circumferential wall 35 is formed integrally with the rotary electric machine case 12 (end side wall 36).

However, the second inner circumferential wall 35 may be constituted of a circumferential wall main body portion that is integral with the rotary electric machine case 12 (end side wall 36) similarly to the first inner circumferential wall 32 and a cylindrical member as a separate body.

An annular partition wall 37 which is a cover member having a cylindrical shape is provided on an outer circumferential surface of the first inner circumferential wall 32 of the first side case 19 and an outer circumferential surface of the second inner circumferential wall 35 of the second side case 20. The annular partition wall 37 is formed of, for example, a resin material. However, the annular partition wall 37 can be also formed of another material such as a metal material. The annular partition wall 37 has a first end portion 37f that faces the inside of the first liquid room 21, a second end portion 37s that faces the inside of the second liquid room 22, and a partition wall main body portion 37b that is located between the first end portion 37f and the second end portion 37s and faces an inner circumferential surface of the stator core 14. The first end portion 37f is formed to have the same inner diameter as the partition wall main body portion 37b. The diameter of a middle portion in an extension direction of the second end portion 37s is reduced in a step manner with respect to the partition wall main body portion 37b.

An inner circumferential surface of the first end portion 37f is slidably fitted to an outer circumferential surface of the cylindrical member 34 of the first inner circumferential wall 32. An annular groove 38f is formed on the outer circumferential surface of the cylindrical member 34, and a seal member 39f having an annular shape such as an O-ring is attached to the annular groove 38f. A space between the cylindrical member 34 (first inner circumferential wall 32) and the first end portion 37f (annular partition wall 37) is sealed in a liquid-tight manner by the seal member 39f.

In the present embodiment, the first end portion 37f constitutes, at the inside of the first liquid room 21, a guide member that guides the cooling liquid in the first liquid room 21 to the slot 31 on a first end side in the axis direction of the stator core 14.

An inner circumferential surface of a reduced diameter section of the second end portion 37s is slidably fitted to an outer circumferential surface of the second inner circumferential wall 35. An annular groove 38s is formed on the outer circumferential surface of the second inner circumferential wall 35, and a seal member 39s having an annular shape such as an O-ring is attached to the annular groove 38s. A space between the second inner circumferential wall 35 and the second end portion 37s (annular partition wall 37) is sealed in a liquid-tight manner by the seal member 39f.

In the annular partition wall 37, as described above, the first end portion 37f is fitted in a liquid-tight manner to the first inner circumferential wall 32 of the first side case 19, and the second end portion 37s is fitted in a liquid-tight manner to the second inner circumferential wall 35 of the second side case 20. The annular partition wall 37 separates an inner region in the radial direction of the stator core 14 attached to the inside of the rotary electric machine case 12 from the outer circumferential surface of the rotor 11. Therefore, even if the cooling liquid 23 leaks out from the slot 31 of the stator core 14 to the inner region in the radial direction, it is possible to prevent the cooling liquid 23 from flowing into the outer circumferential surface side of the rotor 11.

Further, an outer circumferential surface of the first end portion 37f of the annular partition wall 37 expands further outward in the radial direction than an outer circumferential surface of the partition wall main body portion 37b. An end section of this expansion portion on the stator core 14 side stands outward in the radial direction in a step manner with respect to the outer circumferential surface of the partition wall main body portion 37b. This standing end surface is in contact with an end surface on the first end side in the axis direction of the stator core 14.

As shown in FIG. 2, the outer circumferential surface of the partition wall main body portion 37b of the annular partition wall 37 is maintained in a state of being in contact with the inner circumferential surface of the stator core 14. Further, the inner circumferential surface of the partition wall main body portion 37b of the annular partition wall 37 faces the outer circumferential surface of the rotor 11 with a small gap so as to be non-contact with the outer circumferential surface of the rotor 11.

Here, the foamable adhesion bond on the outer surface side foams by heating or the like, and thereby, the foamable insulation member 43 that is accommodated and arranged in each slot 31 of the stator core 14 together with the plurality of slot insertion portions 15a of the coil 15 enters the inside of the opening 40 at the inside in the radial direction of the slot 31. The foamable adhesion bond that has entered the inside of the opening 40 is bonded to an outer circumferential surface of the annular partition wall 37 that is arranged at the outside of the opening 40. As a result, the circumferential wall main body portion 12a of the annular partition wall 37 is bonded and fixed to the foamable insulation member 43 at the inside of the plurality of slots 31 through the opening 40 of the slot 31.

In the rotary electric machine 1 having the configuration described above, when a current continuously flows through the coil 15 at the time of operation, the coil 15 generates heat and becomes a high temperature.

At this time, the cooling liquid 23 is introduced into the first liquid room 21 of the rotary electric machine 1 through the introduction port 24 from the circulation circuit 25. The cooling liquid 23 that is introduced into the first liquid room 21 flows in the first liquid room 21 and thereby cools a region (the drawn portion 15b) on a first end portion side of the coil 15 that is exposed to the outside from the first end side in the axis direction of the stator core 14. Further, the cooling liquid 23 flows through the plurality of slots 31 (cooling liquid passage 44 in the slots 31) of the stator core 14 from a first end side in the axis direction toward a second end side and flows into the second liquid room 22. The cooling liquid that flows through the inside of the slot 31 cools the slot insertion portion 15a of the coil 15 that is inserted through the inside of the slot 31. Further, the cooling liquid 23 that flows into the second liquid room 22 cools a region on a second end portion side of the coil 15 that is exposed to the outside from the second end side in the axis direction of the stator core 14 and is then caused to return to the circulation circuit 25 through the discharge port 26.

In the rotary electric machine 1, the stator 10 is constantly submerged in the cooling liquid 23 in the rotary electric machine case 12 as described above, and in that state, the cooling liquid 23 in the rotary electric machine case 12 is replaced through the circulation circuit 25. Therefore, the coil 15 of the stator 10 is efficiently cooled by the cooling liquid 23.

As described above, in the rotary electric machine 1 of the present embodiment, the recess groove 50 is provided on the outer surface of the coil 15, and the temperature sensor 70 is in contact with the inner surface of the recess groove 50. Then, the outside of the temperature sensor 70 is covered by the holding member 61 in that state, and the temperature sensor 70 is attached to the coil 15 via the holding member 61. Therefore, the temperature sensor 70 is in contact with a portion having a large area in the recess groove 50 of the outer surface of the coil 15, and the outside of the temperature sensor 70 is covered by the holding member 61. Thereby, a temperature determination portion of the temperature sensor 70 can quickly and accurately determine the temperature (temperature change) of the coil 15 without being greatly affected by the temperature of the peripheral cooling liquid 23.

Accordingly, when the rotary electric machine 1 of the present embodiment is employed, it is possible to quickly and accurately determine the temperature of the coil 15 that is arranged to face the flow path of the cooling liquid 23.

Further, in the rotary electric machine 1 of the present embodiment, the holding groove 62 that has a recess shape and holds the outer surface of the temperature sensor 70 in a state of being in contact with the outer surface of the temperature sensor 70 is formed on one sandwiching wall 61a of the holding member 61. Therefore, the outer surface of the temperature sensor 70 is in contact with a portion having a large area in the holding groove 62 of the holding member 61.

Accordingly, when the present configuration is employed, the outer surface of the temperature sensor 70 is not likely to directly come into contact with the cooling liquid 23, and the determination result of the temperature sensor 70 is less likely to be affected by the temperature of the cooling liquid 23.

Further, the rotary electric machine 1 of the present embodiment has a configuration in which the first liquid room 21 and the second liquid room 22 are provided on a first end side and a second end side in the axis direction of the stator core 14, respectively, and by utilizing the plurality of slots 31 of the stator core 14, the cooling liquid is caused to flow from the first liquid room 21 to the second liquid room 22. That is, in the rotary electric machine 1 of the present embodiment, the plurality of slots 31 of the stator core 14 constitute the flow path of the cooling liquid 23 together with the first liquid room 21 and the second liquid room 22.

Accordingly, when the present configuration is employed, almost the entire region of the stator core 14 and the coil 15 is submerged in the cooling liquid 23, and it becomes possible to efficiently cool the stator core 14 and the coil 15 by the cooling liquid 23.

Further, in the rotary electric machine 1 of the present embodiment, the temperature sensor 70 is attached to the coil 15 (the drawn portion 15b) by the holding member 61 at a position that faces the second liquid room 22. Therefore, the temperature sensor 70 determines the temperature of the coil 15 at a downstream-side position of the flow path of the cooling liquid 23 in the rotary electric machine case 12 across the stator core 14.

Accordingly, when the present configuration is employed, it becomes possible to quickly and accurately determine the temperature of a portion of the coil 15 that is most likely to be at a high temperature by the temperature sensor 70.

Further, in the rotary electric machine 1 of the present embodiment, the recess groove 50 is formed along the extension direction of the coil 15 also on the slot insertion portion 15a of the coil 15, and the recess groove 50 of the slot insertion portion 15a forms a communication gap in which the cooling liquid flows in the inside of the slot 31. Therefore, it is possible to cause the cooling liquid 23 to flow by utilizing the recess groove 50 on the outer surface of the slot insertion portion 15a and thereby efficiently cool the coil 15 (slot insertion portion 15a) by the cooling liquid 23.

In the case of the present embodiment, the recess groove 50 that is formed on the outer surface of the slot insertion portion 15a of the coil 15 and the recess groove 50 that is formed on the outer surface of the drawn portion 15b are formed continuously on the same surface of a substantially rectangular cross section of the coil 15. Therefore, the continuous recess groove 50 can be easily formed on the outer surfaces of the slot insertion portion 15a and the drawn portion 15b by press working or the like.

Further, in the rotary electric machine 1 of the present embodiment, the temperature sensor 70 and the coil 15 (drawn portion 15b) are simultaneously sandwiched by the holding member 61 which is an integral resin component, and thereby, the temperature sensor 70 is fixed to the coil 15. Therefore, the temperature sensor 70 can be stably attached to an arbitrary position of the drawn portion 15b of the coil 15 by the holding member 61 having a simple structure that is easily manufactured.

The present invention is not limited to the embodiment described above, and various design changes can be made without departing from the scope of the invention. For example, in the embodiment described above, the temperature sensor 70 is attached to the drawn portion 15b of the coil 15 on the side that faces the second liquid room 22; however, the temperature sensor 70 may be attached to the drawn portion 15b of the coil 15 on a side that faces the first liquid room 21.

Further, in the embodiment described above, the holding member 61 is constituted of an integral resin component having the pair of sandwiching walls 61a, 61b; however the structure and the material of the holding member 61 are not limited thereto.

The holding member 61 may be, for example, a component having a clip form constituted of a plurality of components, and the material is also not limited to a resin and may be a metal or a material other than the resin.

Further, in the embodiment described above, a structure in which almost the entire region of the stator core 14 and the coil 15 is completely submerged in the cooling liquid 23 is employed; however, a cooling portion of the stator core 14 and the coil 15 may not necessarily have this structure. For example, the cooling portion of the stator core 14 and the coil 15 may be a structure in which the cooling liquid 23 is injected or a structure in which the cooling liquid 23 is dropped from above.

Further, in the embodiment described above, the holding groove 62 that holds the outer surface of the temperature sensor 70 is formed on the sandwiching wall 61a of the holding member 61; however, for example, when the outer surface of the temperature sensor 70 has a flat shape, the holding groove 62 may not necessarily be provided.

What is claimed is:

1. A rotary electric machine comprising:
a stator having a stator core and a coil that is wound around the stator core;
a rotor that rotates relative to the stator;
a rotary electric machine case which has an inner portion that accommodates the stator and the rotor and in which a flow path of a cooling liquid for cooling the stator is provided in the inner portion; and
a temperature sensor that is in contact with the coil at a position facing the flow path and determines a temperature of the coil,
wherein a recess groove is provided on an outer surface of the coil,
an outside of the temperature sensor is covered by a holding member in a state where the temperature sensor is in contact with an inner surface of the recess groove, and
the temperature sensor is attached to the coil via the holding member.

2. The rotary electric machine according to claim 1,
wherein a holding groove that has a recess shape and holds an outer surface of the temperature sensor in a state of being in contact with the outer surface of the temperature sensor is formed on the holding member.

3. The rotary electric machine according to claim 1,
wherein a first liquid room that faces an end surface on a first side in an axis direction of the stator core and a second liquid room that faces an end portion on a second side in the axis direction of the stator core are provided inside the rotary electric machine case,
a plurality of slots which penetrate through the stator core in the axis direction and through which the coil is inserted are provided on the stator core, and
the plurality of slots cause the cooling liquid that is introduced into the first liquid room to flow to a side of the second liquid room and constitute the flow path together with the first liquid room and the second liquid room.

4. The rotary electric machine according to claim 3,
wherein the temperature sensor is attached to the coil by the holding member at a position that faces the second liquid room.

5. The rotary electric machine according to claim 3,
wherein the recess groove is provided continuously along an extension direction of the coil also on a portion that is inserted into the slot of the coil, and
the recess groove forms a communication gap in which the cooling liquid flows in an inside of the slot.

6. The rotary electric machine according to claim 2,
wherein a first liquid room that faces an end surface on a first side in an axis direction of the stator core and a second liquid room that faces an end portion on a second side in the axis direction of the stator core are provided inside the rotary electric machine case,
a plurality of slots which penetrate through the stator core in the axis direction and through which the coil is inserted are provided on the stator core, and
the plurality of slots cause the cooling liquid that is introduced into the first liquid room to flow to a side of the second liquid room and constitute the flow path together with the first liquid room and the second liquid room.

7. The rotary electric machine according to claim 6,
wherein the temperature sensor is attached to the coil by the holding member at a position that faces the second liquid room.

8. The rotary electric machine according to claim 6,
wherein the recess groove is provided continuously along an extension direction of the coil also on a portion that is inserted into the slot of the coil, and
the recess groove forms a communication gap in which the cooling liquid flows in an inside of the slot.
